(19) United States
(12) Patent Application Publication
(10) Pub. No.: US 2012/0320704 A1
(43) Pub. Date: Dec. 20, 2012

(54) HAND MIXER

(76) Inventor: Dilek Cumrali, Los Angeles, CA (US)

(21) Appl. No.: 13/443,592

(22) Filed: Apr. 10, 2012

Related U.S. Application Data
(63) Continuation-in-part of application No. 13/160,161, filed on Jun. 14, 2011.

(51) Int. Cl. B01F 13/00

(52) U.S. Cl. 366/130

(57) ABSTRACT

The invention relates to an improved device for mixing liquid mixtures or liquid-solid mixtures, comprising a container having an opening, a cap having a bottom surface that can cover the opening of the container and at least one protrusion protruding from the bottom surface of the cap.

### CROSS REFERENCE TO RELATED APPLICATION

This application is a continuation-in-part of U.S. patent application Ser. No. 13/160,161, filed Jun. 14, 2011 the disclosure of which is hereby incorporated herein by reference in its entirety

### FIELD OF THE INVENTION

This invention relates to the field of mixing or blending liquid mixtures, such as foods or pharmaceuticals, omelet mixes, protein shakes, chocolate milk, powdered medicines dissolved in aqueous solutions, etc.

### BACKGROUND OF THE INVENTION

Traditionally, mixing or blending such substances involved either the use of a utensil, such as a mixing stick, beater or spoon, to manually stir the mixture of elements until it is properly mixed, or an appliance such as a blender or food processor to accomplish the same. However stifling takes time and effort, and can lead to an uneven mixture. For example, when mixing a protein shake, clumps of protein powder may avoid the mixing utensil, and thereby not properly dissolve into the liquid with which it is being mixed. Similarly, appliances can produce a more consistent mixture, but require electricity or batteries to work and must generally be disassembled in order to clean.

Screw or hinge-top containers allow the mixing of such substances by hand-shaking the entire container. However, such containers do not have any interior structure to disrupt the flow of liquid through them, and the mixture obtained through such manual shaking may therefore be prone to inconsistency. More recently, as described in U.S. Pat. No. 6,379,032, companies have tried introducing independent structures as agitators to disrupt the flow of liquid while mixing in order to improve the consistency of the mixture. However such products are disadvantageous in that they require a separate structure to work, which increases costs, and places a burden on the consumer to not lose the separate structure.

Another drawback of the prior art is that the mixing process is inherently messy and, when liquids are used, there is a good possibility that an improperly sealed mixing container will leak. In addition, is a user's hands should become wet or slippery, it is difficult to hold the container while shaking it, and to tighten or loosen the cap for filling or emptying the container.

### SUMMARY OF THE INVENTION

This invention overcomes the drawbacks of the prior art by providing an improved hand mixer that has rigid protrusions, which may be spikes, and which may take on any one of a number of shapes, at one or both ends that break up and mix any substance in the container as it is being shaken. A large cap having indentations about the circumference assists a user in tightening or loosening the cap. An inner liner within the cap provides a barrier to hold the mixed substance away from the edges of the cap until the cap is removed for pouring. This reduces the user's exposure to the mixed substance, and reduces the possibility of leaks around the cap, and the incidence of wet or slippery hands that could come into contact with the leaked mixture. The container is “dog-bone” shaped, being larger in diameter at either end, and having a smaller diameter section between the two ends. Markings on the container may be used to assist in measuring ingredients to be mixed, and a bottom removable cap may be used to aid in cleaning the mixer.

An objective of the present invention is to overcome the limitations of the prior art by introducing structure to disrupt flow of liquid through the bottle.

Another objective of the present invention is to prevent the liquid inside the container from leaking between cap and the container.

Another objective of the present invention is to provide a container that does not tip over easily.

A further objective of the present invention is to provide a container that is easily grasped and held, even if the user's hands should be wet or slippery.

### BRIEF DESCRIPTION OF THE DRAWINGS

A system realized to fulfill the objective of the present invention is illustrated in the accompanying figures, in which:

FIG. 1 shows a side view of the hand mixer.

FIG. 2 shows a side view of the cap.

FIG. 3 shows a cross-sectional view of the cap.

FIG. 4 shows a side view of the container.

FIG. 5 shows a cross-sectional view of the container.

FIG. 6 shows a cross-sectional view of the hand mixer.

FIG. 7 shows a cross-sectional view of the hand mixer having two caps.

FIG. 8 shows a cross-sectional view of the hand mixer having two caps one which has a straight surface

FIG. 9 shows a perspective view of an embodiment of the hand mixer, with the cap of the container removed.

FIG. 10 shows a bottom view of an embodiment of the cap.

FIGS. 11a, 11b, 11c, 11d Show bottom and perspective views of different types of the protrusions.

FIGS. 12a and 12b show side views of different types of protrusions having helical ridges.

### DETAILED DESCRIPTION OF THE PREFERRED EMBODIMENTS

The components illustrated in the figures are individually numbered where the numerals refer to the following:

1 Hand mixer

2 Container

21 Opening

22 Base

3 Cap

31 Protrusion

32 Tapering point

33 Ridge

34 Barrier

35 Indentations

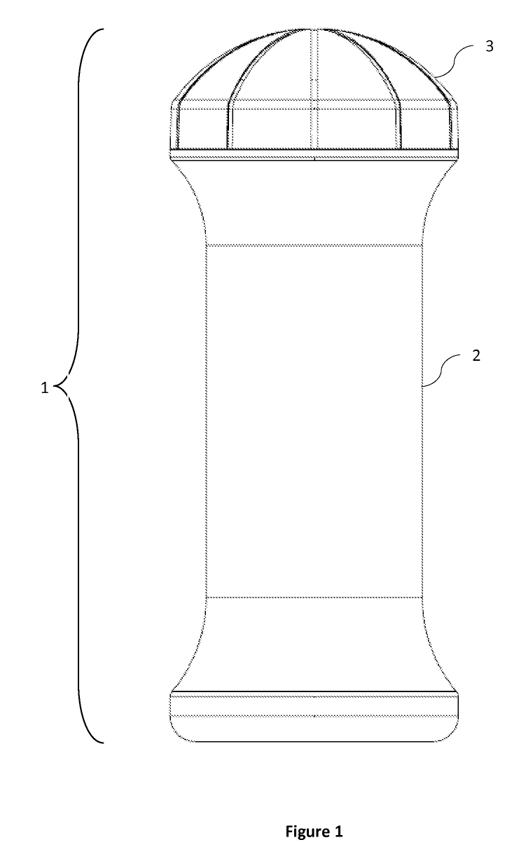

FIG. 1 depicts a hand mixer 1, which homogenously mixes the liquid-liquid and/or liquid-solid mixtures such as foods, pharmaceuticals, omelet mixtures, protein shakes, powdered medicines dissolved in aqueous solutions, or similar substances. A cap 3 is attached to container 2 by any means that will result in a secure seal between the cap 3 and the container 2. In a preferred embodiment, cap 3 will have pronounced indentations 35 to assist a user in gripping and twisting the cap, and will be in threaded engagement with the container 2. Container 2 has a larger diameter at at least one end, and a smaller diameter for most of its length. In a preferred embodiment, the container 2 flares outward at the base 22, which is flat and permits the hand mixer to stand unattended.

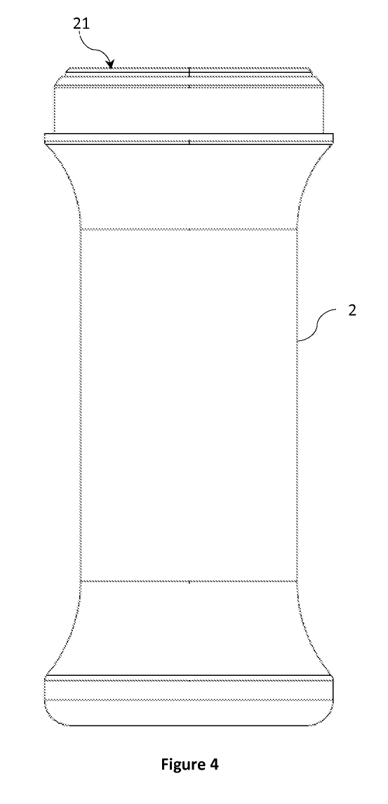

The container 2 can be rigid or flexible, and can be made of plastic, glass, metal, wood, clay, rubber, or any other material or combination of materials known in the art. The container 2 is preferably made of a transparent material and has a scale showing the amount of the mixture inside the container 2. In FIG. 4, the container 2 has an opening 21, through which the substances to be mixed can be placed into the container 2.

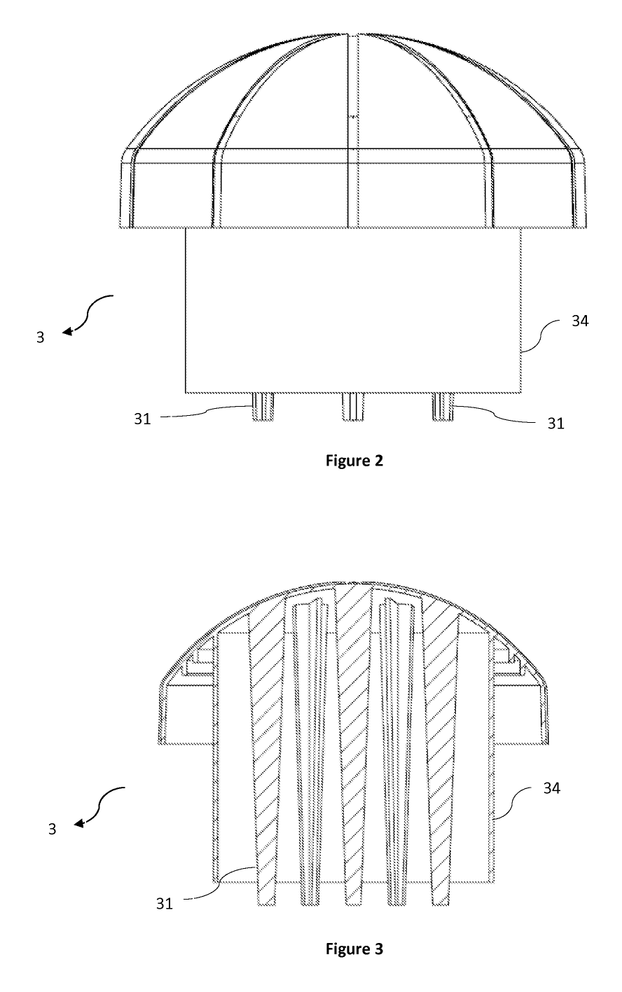

FIG. 2 depicts a cap 3, or lid, which covers the opening 21 of the container 2, such that the substances being mixed remain inside the container during mixing, and do not spill out. The cap 3, or lid, may be made of plastic, glass, metal, wood, clay, rubber or any other material or combination of materials know in the art. Optionally, rubber O-rings, or any similar structures known in the art may also be used to help seal the connection between the cap 3 and the container 2. The cap 3 may attach to the container by threaded engagement (such as a screw and thread mechanism), by using a cam mechanism (such as an over-center cam mechanism), clipping on, form fitting attachment mechanism (such as a detent and groove mechanism), or any other form of attachment known in the art.

The invention further comprises at least one, and preferably more than one protrusion(s) 31. As shown in cross-section in FIG. 3, the protrusion(s) 31 are affixed to the interior surface of the cap 3, or lid, such that they extend into the container 2 when the cap 3, or lid, is attached. The protrusions 31 can be made of plastic, glass, metal, wood, clay, rubber, or any other suitable material or combinations of materials known in the art. In some embodiments, the protrusion(s) 31 may be separate structures that are attached to the lid through mechanical fasteners or through adhesion form-fitting connections, or other attachment methods known in the art. Where the protrusions 31 are separate structures, in certain embodiments, the protrusions 31 may be detachable (for example, for cleaning or so that the container can be used without the protrusions in the cap), such that they can be attached or removed as desired, and when they are connected they remain secured to the interior surface of the cap 3. In such embodiments the protrusions 31 may be secured to the cap by any means known in the art, including without limitation, clipping onto a retaining structure, sliding them into place, slide and lock mechanisms, detent and groove mechanisms, threaded engagement, form fitting connections (e.g. dove tails), etc. The protrusions 31 may be attached and detached from the interior surface of the cap 3 individually, in groups, or all together as one piece. Alternatively the protrusion(s) 31 may be an integral part of the structure of the cap 3, or lid. For example, a mold for a molded plastic cap 3 may include the protrusion(s) 31 such that the cap 3 and the protrusion(s) 31 are formed of a single piece.

The protrusion(s) 31 may be arranged in any manner desired. For example, in embodiments with a single protrusion 31 on the cap 3, or lid, the protrusion 31 may be centered on the cap 3, or lid, or may be off-center. In embodiments with multiple protrusions 31, the protrusions 31 may be arranged in symmetric or asymmetric patterns. As shown in FIG. 10, the protrusions 31 may be arranged in staggered rows, or they may be arranged in a grid pattern (not shown).

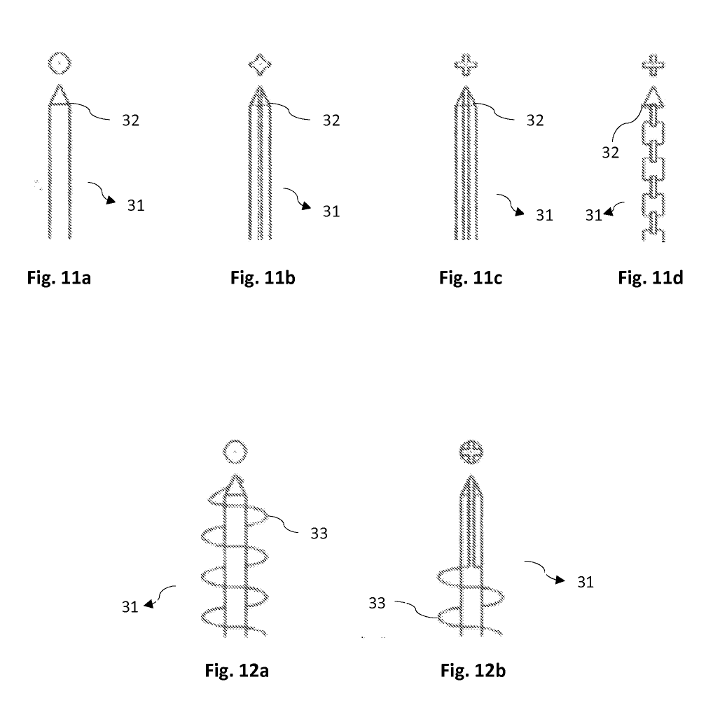

Similarly, the protrusions may have any desired shape. Examples of possible shapes are shown in FIGS. 11a, 11b and 11c. In FIG. 11a a cylindrical protrusion 31 is shown wherein the protrusion 31 is cylindrical from its base to a taper point 32, after which the cylindrical protrusion tapers in the shape of a cone. In FIG. 11b, the protrusion 31 is fluted, and likewise tapers after a tapering point 32. In FIG. 11c, the protrusion 4 is cross-shaped and tapered after a tapering point 32. FIG. 11d shows an alternative type of cross-shaped protrusion 31 wherein the cross is formed by rectangular structures with alternating orientations. Optionally, cylindrical, fluted or cross-shaped protrusions 31 that do not taper may be used. Alternatively, protrusions 31 having other polygonal shapes, or other star-type shapes, or having discs spaced longitudinally along the protrusions may be used. These examples are meant to be illustrative rather than limiting, as one of skill in the art will recognize that such protrusions 31 can take on a variety of shapes and sizes.

As shown in FIGS. 12a and 12b, the protrusions 31 may optionally have a helical ridge 33, which extends around the sides of the protrusion 31, giving it a shape similar to that of a screw. The helical ridge 33 may extend along the entire length of the protrusion 31 (FIG. 12a). Alternatively, the helical ridge 33 may only extend along a part of the protrusion 31 (FIG. 12b). The shape of the protrusions 31 need not be consistent along its length (FIG. 12b. The protrusion 31 shown in FIG. 12b is cylindrical with a helical ridge 33 at the bottom, and is cross-shaped without a helical ridge 33 at the top. In an alternative embodiment, rings or discs may be used in place of the illustrated helical structure. Such structures assist in the mixing process by creating swirls and eddies, and by presenting irregular surfaces to a mixture being agitated, thereby enhancing the integration of substances being mixed.

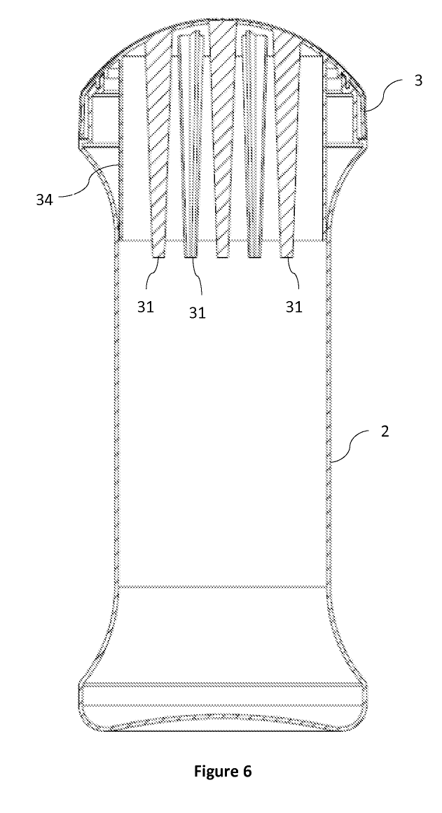

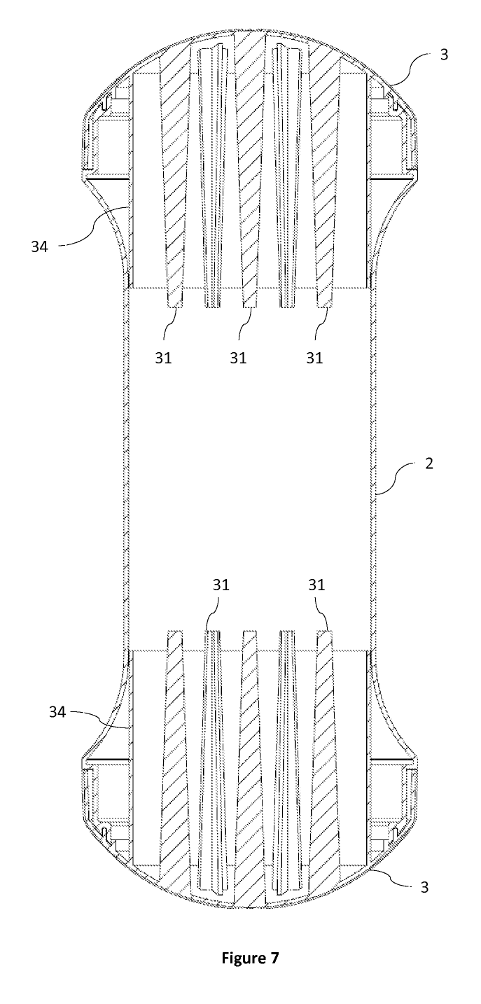

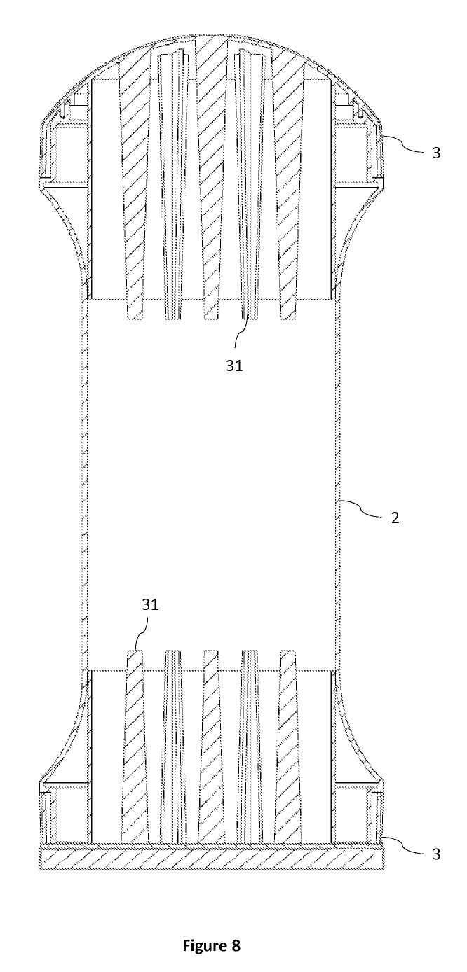

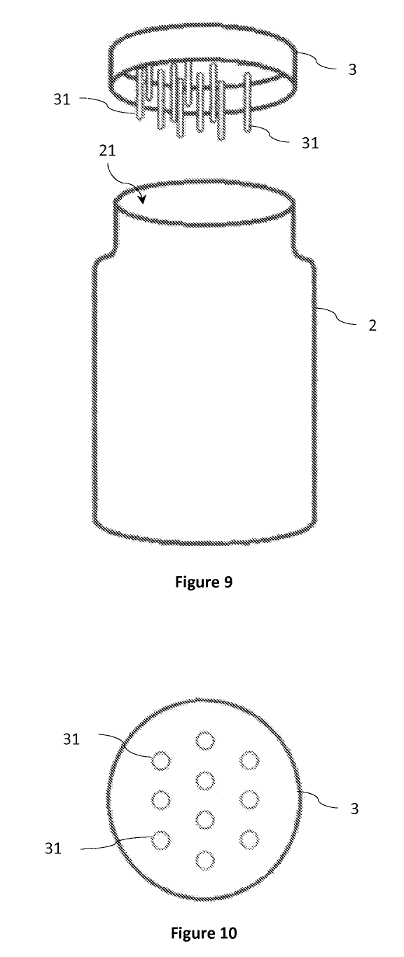

The invention preferably comprises a barrier 34 affixed to the interior surface of the cap 3. As may be seen in FIG. 6, the barrier 34 has a diameter similar to the interior diameter of the container 2 where the barrier 34 extends downwardly into the container 2. When the cap 3 is tightly closed, the outer surface of the barrier 34 fits close to, or may even contact, the interior surface of the opening 21, to prevent the mixture inside the container 2 from leaking between the cap 3 and the container 2 (FIGS. 6, 7, 8). In some embodiments, barrier 34 may even have a flexible seal (not shown) extending around the lower circumference of the barrier to contact the interior surface of container 2 and prevent the mixed substance from leaking into the flared area where cap 3 is attached at the top of container 2.

The invention can be practiced with containers having modified configurations. For example the container 2 may have a handle, grips, depressions for fingers, or may otherwise be shaped in any manner known in the art such that it is easier to hold while it is being shaken. In some embodiments, the container 2 may also have one or more additional openings 21, each having a corresponding cap 3 that may or may not include protrusions. In such embodiments, it is not necessary to remove the cap 3 having the protrusions 31 from the container 2 in order to extract the mixture from within the container 2. Alternatively, in multiple-cap embodiments each cap 3 may have protrusions 31.

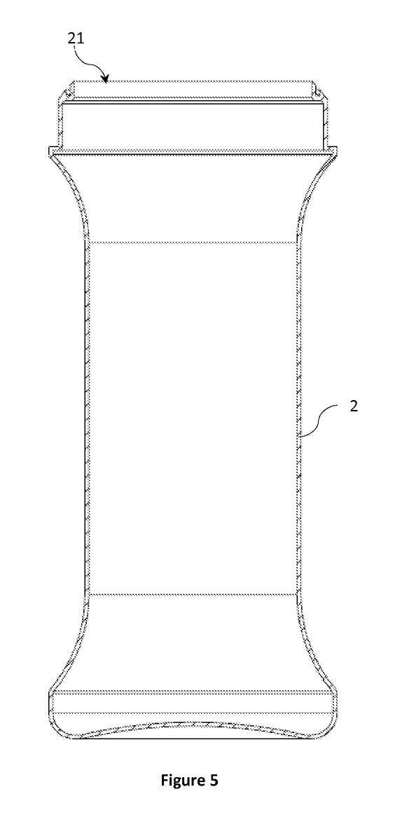

In a preferred embodiment, the base of the container 2 has an outer diameter larger than the outer diameter of upper part of the container 2 (FIGS. 1, 4, 5, 6). This provides the hand mixer 1 with a secure base to prevent it from tipping over easily.

Within the scope of these basic concepts, it is possible to develop a wide variety of embodiments of the improved hand mixer 1. The invention is not limited to the examples described herein, but is limited only by the claims appended hereto and equivalents thereof.

I claim:

1. An improved hand mixer comprising:
at least one cap and a container;
said container further comprising an enlarged upper portion and a smaller central portion,
said enlarged portion further comprising an opening through which substances to be mixed can be placed into said container,
said at least one cap further comprising
an inner surface adapted to fit over said opening of said container to form a seal, said cap characterized by one or more protrusions extending from said interior surface of said cap into said container,
a barrier extending from said interior surface of said cap around said protrusions and downwardly into said lower portion of said container, said barrier having an outer surface engaging at least a portion of the inner surface of said lower portion of said container such that said barrier inhibits substances to be mixed from migrating into said upper portion of said container outside said barrier during operation of said improved hand mixer.

2. The improved hand mixer according to claim 1 further comprising said protrusions extending from said interior surface of said cap are integrally formed with said cap.

3. The improved hand mixer according to claim 1, at least one of said protrusions comprising a helical ridge.

4. The improved hand mixer according to claim 3, said helical ridge extending along the entire length of said at least one protrusion.

5. The improved hand mixer according to claim 1 in which said one or more protrusions comprises a plurality of protrusions.

6. The hand mixer according to claim 5 said protrusions further comprise one or more disks spaced longitudinally along said protrusions.

7. The hand mixer according to claim 5 comprising said protrusions being arranged in a grid pattern.

8. The hand mixer according to claim 5 comprising protrusions being arranged in staggered-row pattern.

9. The hand mixer according to claim 1 wherein at least one of said one or more protrusions is cylindrical in shape.

10. The hand mixer according to claim 1 wherein at least one of said one or more protrusions is fluted in shape.

11. The hand mixer according to claim 1 wherein at least one of said one or more protrusions is cross-shaped.

12. The hand mixer according to claim 1 wherein said container further comprises at least two openings.

13. The hand mixer according to claim 1 wherein at least one of said one or more protrusions can be attached and detached from said inner surface of said cap.

14. The hand mixer according to claim 5 wherein said plurality of protrusions can be attached and detached from said inner surface of said cap.

15. The hand mixer according to claim 1 wherein the outer surface of said barrier fits tightly against at least a part of the inner surface of said container.

16. The hand mixer according to claim 1 wherein said container has a lower portion comprising a base, said base having an outer diameter larger than the outer diameter of said central portion.

17. The hand mixer according to claim 1 wherein the inner diameter of said opening is larger than the outer diameter of said barrier.

18. The hand mixer 1 according to claim 17 wherein the lowest extremity of said barrier contacts and fits snugly within said inner surface of said container, and the inner diameter of said container increases from the point of contact with said lowest extremity of said barrier upwardly to a maximum diameter at said opening.

19. A hand mixer comprising a container and two caps, said container being generally cylindrical and comprising two openings at opposing ends of said container, the diameter of said container being greater at said openings and decreasing at a central portion;
each said cap being configured to securely seal opening during operation, each said cap further comprising a plurality of pointed protrusions situated on an inner surface of said cap and extending into said container when said cap is covering said opening,
each said cap further comprising a barrier forming a complete loop around said plurality of pointed protrusions and extending into said container, the lower portion of said barrier being in contact with the inner surface of said central portion of said container to form a seal around the inner surface of said central portion of said container when each respective said cap is securely attached to an opening of said container.
